(19) United States
(12) Patent Application Publication
(10) Pub. No.: US 2026/0249751 A1
(43) Pub. Date: Aug. 27, 2026

(54) SEAT SHELL HAVING MULTIPLE BELT PATHS

(71) Applicant: Dorel Juvenile Group, Inc., Foxboro, MA (US)

(72) Inventors: Grant M. MASON, Wrentham, MA (US); Kegan McKinney CRAWFORD, Foxboro, MA (US); Nathan W. HEISEY, Seymour, IN (US)

(21) Appl. No.: 19/548,277

(22) Filed: Feb. 24, 2026

Related U.S. Application Data
(60) Provisional application No. 63/762,922, filed on Feb. 25, 2025.

(51) Int. Cl. B60N 2/28

(52) U.S. Cl. CPC B60N 2/2806; B60N 2/2821; B60N 2/2869

(57) ABSTRACT

A child restraint includes a seat base and a juvenile seat. The seat base is adapted to rest on an underlying vehicle seat. The juvenile seat is coupled to the seat base to support a child for transportation and includes a seat bottom coupled to the seat base and a backrest coupled to the seat bottom and arranged to extend in an upward direction away from the seat bottom. The juvenile seat is formed to include a belt path to attach the child restraint to the vehicle seat.

### PRIORITY CLAIM

This application claims priority under 35 U.S.C. § 119(e) to U.S. Provisional Patent Application No. 63/762,922, filed February 25, 2025, which is expressly incorporated by reference herein in its entirety.

### BACKGROUND

The present disclosure relates to a child safety device, and particularly to a child restraint. More particularly, the present disclosure relates to a child restraint configured to be attached to a vehicle.

### SUMMARY

According to the present disclosure, a child restraint includes a seat base adapted to rest on an underlying vehicle seat and a juvenile seat coupled to the seat base. The juvenile seat includes a seat bottom coupled to the seat base and a backrest coupled to the seat bottom and arranged to extend in an upward direction away from the seat bottom. In some embodiments, the juvenile seat is configured to rotate relative to the seat base about a vertical pivot axis between a forward-facing orientation and a rearward-facing orientation.

In illustrative embodiments, the juvenile seat is formed to include a first belt path, a second belt path, and a third belt path. The first belt path is formed in the backrest and is configured to receive a vehicle seat belt when the juvenile seat is in the forward-facing orientation to establish a forward-facing seating mode. The second belt path is formed in the seat bottom and is located forward of the first belt path relative to the vertical pivot axis and a front end of the juvenile seat and configured to receive the vehicle seat belt when the juvenile seat is in the forward-facing orientation to establish a forward-facing booster mode. The third belt path is formed in the seat bottom and is located forward of the second belt path relative to the vertical pivot axis and the front end of the juvenile seat and configured to receive the vehicle seat belt when the juvenile seat is in the rearward-facing orientation to establish a rearward-facing seating mode.

In illustrative embodiments, the child restraint further includes a belt lock-off coupled to the backrest of the juvenile seat and located in the first belt path to retain the vehicle seat belt when the juvenile seat is in the forward-facing seating mode. The backrest includes a seating surface configured to support a portion of a child seated on the juvenile seat and a rear surface facing away from the seating surface and spaced apart from the seating surface to provide a cavity between the seating surface and the rear surface. The first belt path extends through the cavity and the belt lock-off is located in the cavity between the seating surface and the rear surface.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a child restraint including a seat base and a juvenile seat coupled to the seat base, and suggesting that the juvenile seat is pivotable about a vertical pivot axis between a forward-facing orientation as shown in FIG. 2 to a rearward-facing orientation as shown in FIG. 7, the juvenile seat including a seat bottom, a backrest coupled to the seat bottom, and a headrest coupled to the backrest;

FIG. 2 is a side elevation and diagrammatic view of the child restraint of FIG. 1 showing the juvenile seat formed to include: (i) a first belt path formed in the backrest and configured to receive a vehicle seat belt when the juvenile seat is in the forward-facing orientation to establish a forward-facing seating mode, (ii) a second belt path formed in the seat bottom and located forward of the first belt path relative to the vertical pivot axis and a front end of the juvenile seat and configured to receive the vehicle seat belt when the juvenile seat is in the forward-facing orientation to establish a forward-facing booster mode, and (iii) a third belt path formed in the seat bottom and located forward of the second belt path relative to the vertical pivot axis and the front end of the juvenile seat and configured to receive the vehicle seat belt when the juvenile seat is in the rearward-facing orientation to establish a rearward-facing seating mode;

FIG. 3 is a cross section taken along line 3-3 in FIG. 1 showing the first belt path located in a cavity formed in the backrest;

FIG. 4 is an enlarged portion of FIG. 3 showing the first belt path located between a seating surface of the backrest and a rear surface of the backrest facing away from the seating surface;

FIG. 5 is a perspective view of the child restraint showing the seating surface provided by a backrest panel and an access panel coupled to the backrest panel, and showing the access panel in a closed position;

FIG. 6 is a perspective view of the child restraint showing the access panel in an opened position to expose the first belt path and a belt lock-off located in the first belt path; and

FIG. 7 is a side elevation view of the child restraint showing the juvenile seat in the rearward-facing orientation.

### DETAILED DESCRIPTION

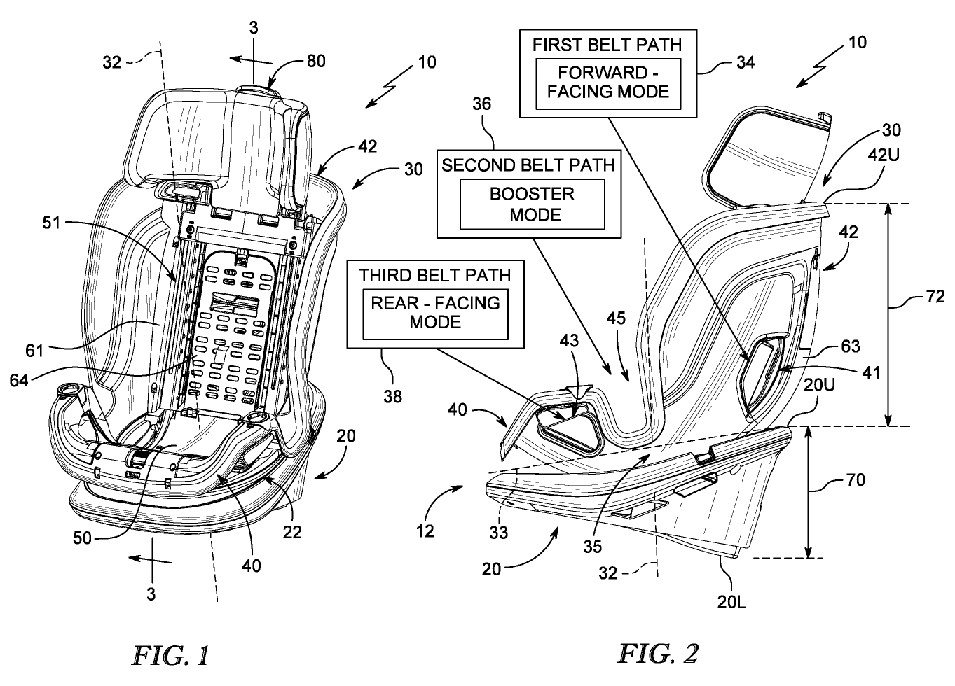

A child restraint 10, in accordance with the present disclosure, is shown in FIG. 1 and includes a seat base 20 and juvenile seat 30 coupled to the seat base 20. The seat base 20 is adapted to rest on an underlying vehicle seat. The seat base 20 is formed to include a recessed area 22 to receive a portion of the juvenile seat 30. The recessed area 22 is shaped to allow the juvenile seat 30 to move relative to the seat base 20 between different orientations to provide multiple modes of the child restraint 10. The juvenile seat 30 is not separable from the seat base 20 under normal use conditions in the illustrative embodiment, but the juvenile seat 30 may be separable from the seat base 20 in other embodiments.

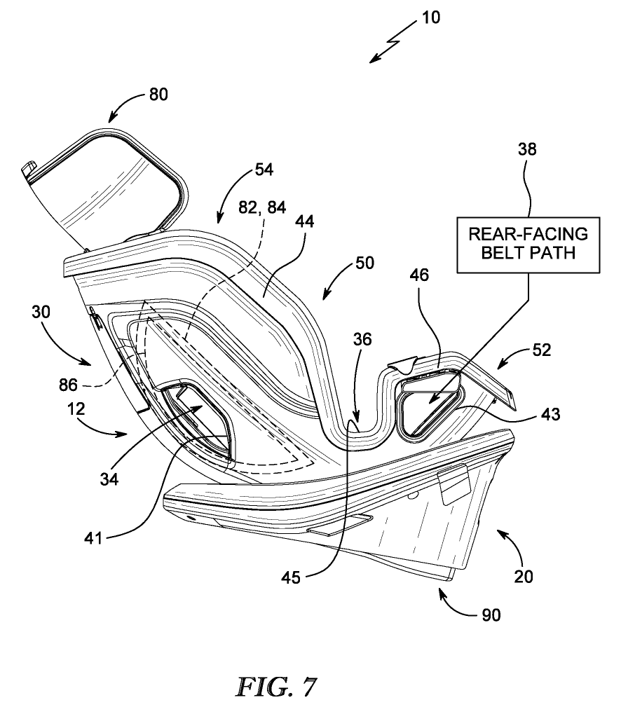

The juvenile seat 30 is configured to rotate relative to the seat base 20 about a vertical pivot axis 32 between a forward-facing orientation as shown in FIGS. 1 and 2, and a rearward-facing orientation, as shown in FIG. 7. The juvenile seat 30 includes a seat bottom 40 coupled to the seat base 20 and a backrest 44 coupled to the seat bottom 40 and arranged to extend in an upward direction away from the seat bottom 40. The bottom 40 forms a bottom seating surface 50 of the juvenile seat 30. The backrest 42 forms a back seating surface 51 of the juvenile seat 30. Together, the bottom seating surface 50 and the back seating surface 51 support the child in either the forward-facing orientation or the rearward-facing orientation.

The juvenile seat 30 is formed to include a first belt path 34, a second belt-path 36, and a third belt path 38 as shown in FIG. 2. The first belt path 34 is formed in the backrest 42 and is configured to receive a vehicle seat belt when the juvenile seat 30 is in the forward-facing orientation to establish a forward-facing seating mode. The second belt path 36 is formed in the seat bottom 40 and is located forward of the first belt path 34 relative to the vertical pivot axis 32 and a front end 12 of the juvenile seat 30. The second belt path 36 is configured to receive the vehicle seat belt when the juvenile seat 30 is in the forward-facing orientation to establish a forward-facing booster mode. The third belt path 38 is formed in the seat bottom 40 and is located forward of the second belt path 36 relative to the vertical pivot axis 32 and the front end 12 of the juvenile seat 30. The third belt path 38 is configured to receive the vehicle seat belt when the juvenile seat 30 is in the rearward-facing orientation to establish a rearward-facing seating mode.

The seat base 20 is relatively small proportionally in comparison to the juvenile seat 30. The seat base 20 is formed without any belt paths for attaching the child restraint 10 to the vehicle seat using the vehicle seat belt. Rather, the juvenile seat 30 is the only part of the child restraint 10 that includes belt paths for attaching the child restraint 10 to the vehicle seat using the vehicle seat belt. This allows the seat base 20 to be made smaller in comparison to other comparable child seats that include one or more belt paths in the seat base. In some embodiments, the seat base 20 may include latches used to attach the seat base 20 to anchor points included in the vehicle seat.

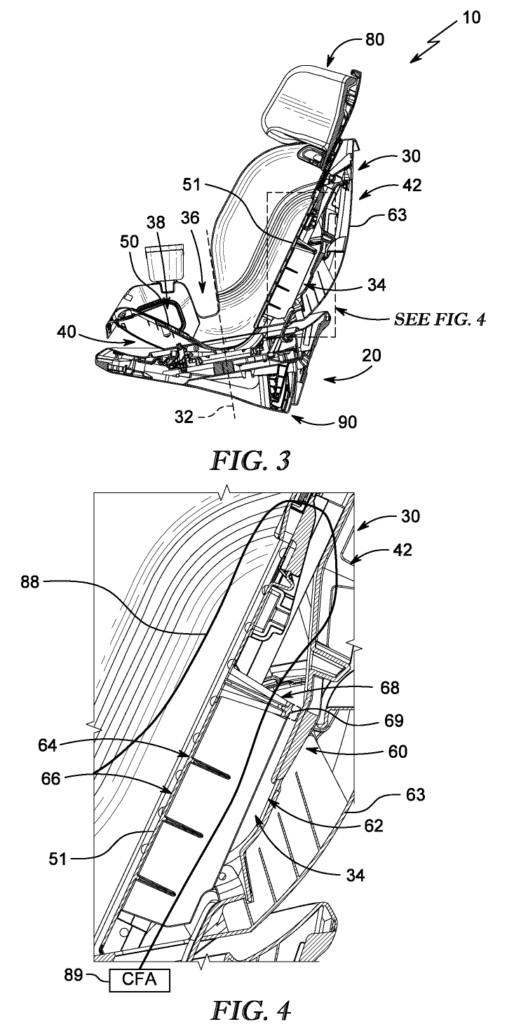

The seat base 20 has a first height 70 from a lower end 20L of the seat base 20 engaged with the vehicle seat to an uppermost end 20U of the seat base 20 spaced apart from the vehicle seat as shown in FIG. 3. The backrest 42 of the juvenile seat 30 has a second height 72 from the uppermost end 20U of the seat base 20 to an uppermost end 42U of the backrest 42. The second height 72 is greater than the first height 70.

The first belt path 34 is located above the uppermost end 20U of the seat base 20 when the juvenile seat 30 is in the forward-facing orientation. The third belt path 38 is located at least partially above the uppermost end 20U of the seat base 20 when the juvenile seat 30 is in the rearward-facing orientation. The first belt path 34, the second belt path 36, and the third belt path 38 are each located above a plane 33 extending from the uppermost end 20U of the seat base 20 to a point 35 along the vertical pivot axis 32, where the plane 33 is perpendicular to the vertical pivot axis 32. These dimensions contribute to minimizing an overall size of the seat base 20 while still providing a juvenile seat 30 that rotates relative to the seat base 20. Other comparative car seats having a rotating seat also include seat base having dimensions greater than those described above, such as a back portion that extends higher than described to provide a surface for a belt path. The illustrative seat base 20 has a smaller size and no vehicle seat belt paths to decrease a weight and cost of the child restraint 10 as a whole.

The backrest 42 includes a backrest panel 61, a rear panel 63 at least partially spaced apart from the backrest panel 61 to provide a cavity 62 therebetween, and an access panel 64 coupled to the backrest panel 61. The backrest panel 61 and the access panel 64 cooperate to provide the backrest seating surface 51. The rear panel 63 faces away from the seating surface 51. The first belt path 34 extends through the cavity 62 between the seating surface 51 and the rear panel 63 so that the vehicle seat belt does not interfere with the child seated on the juvenile seat 30.

The juvenile seat 30 further includes a belt lock-off 60 located in the cavity 62 to retain the vehicle seat belt in the forward-facing seating mode. The belt lock-off 60 is configured to clamp down on the vehicle seat belt in the first belt path 34. Because the belt lock-off 60 is in the cavity 62, access to the belt lock-off 60 can be challenging. The access panel 64 is coupled to the backrest panel 61 for pivotable movement relative to the backrest panel 61 between a closed position at least partially providing the seating surface 51 and an opened position exposing the cavity 62 from the front end of the juvenile seat 30. In this way, the access panel 64 allows access to the belt lock-off 64 and to facilitate routing the vehicle seat belt through the first belt path 34. Other comparative car seats may include a belt lock-off that forms a part of the seating surface. In such cases, the vehicle seat belt is routed across the seating surface and may twist or be bunched up, thereby decreasing comfort for the child. Soft goods or padding may cover the seating surface 51 to provide more comfort for the child. Such soft goods can be moved away from the seating surface 51 to access the access panel 64.

The access panel 64 includes a panel wall 66 and a lock off brace 68 coupled to the panel wall 66 as shown in FIG. 4. The panel wall 66 provides a portion of the seating surface 51 along the backrest 42. The lock off brace 68 extends from the panel wall 66 into the cavity 62 and toward the belt lock-off 60. The child restraint 10 further includes a harness 88 routed from a central front adjuster (CFA) 89 through the cavity 62 and over the lock off brace 68 as shown in FIG. 4. When the panel 64 is opened, the brace 68 pulls the harness 88 out of the cavity 62 to expose the first belt path 34 and the belt lock-off 60 and facilitate installation of the vehicle seat belt. In other embodiments, the harness 88 may be routed through a separate cavity spaced apart from cavity 62 to bypass the first belt path 34 entirely. The brace 68 also substantially obstructs the first belt path 34 when the access panel 64 is closed to block incorrect installation of the vehicle seat belt.

In some embodiments, a distal end 69 of the lock off brace 68 may be positioned at or near the belt lock-off 60 to block the belt lock-off 60 from releasing the vehicle seat belt when the access panel 64 is in the closed position. In some embodiments, the distal end 69 of the access panel 64 may directly contact the belt lock-off 60 to apply a load on the belt lock-off 60 such that the access panel 64 serves as a second or secondary belt lock-off in conjunction with the belt lock-off 60.

The juvenile seat 30 further includes a headrest 80 coupled to the backrest 42 for movement along the backrest between a lowered position, a raised position, and one or more intermediate positions. The headrest 80 interfaces with the seating surface 51 and at least partially covers the access panel 64 in the lowered position. The headrest 80 has a high range of motion along the backrest 42 extending along a majority of a height of the backrest 42. A high range of motion of the headrest 80 provides more adjustability for the headrest 80 to fit a greater range of heights of children. Because the belt lock-off 60 is positioned behind the seating surface 51 in the cavity 62, the vehicle seat belt does not interfere with a travel path of the headrest 80 along the seating surface 51.

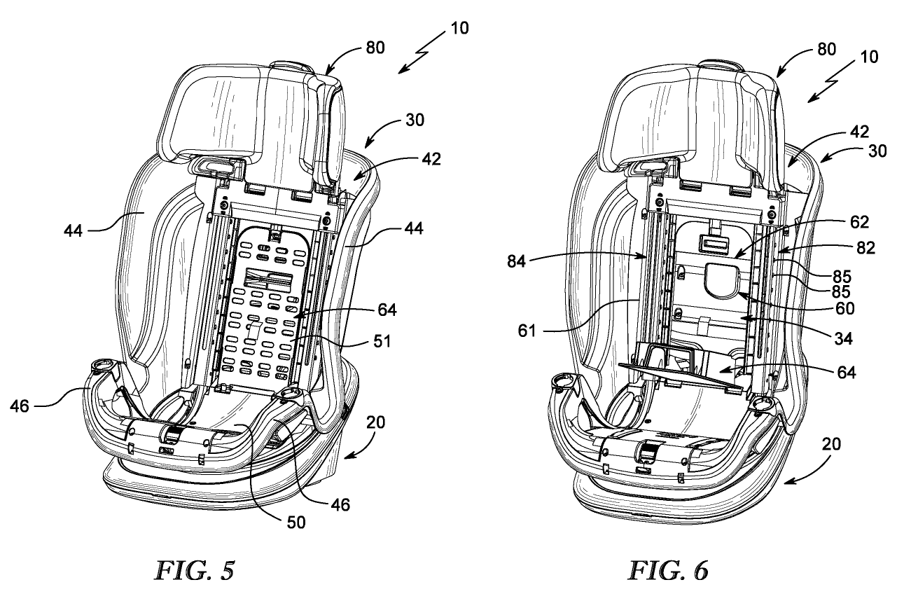

The headrest 80 is coupled to the backrest 42 at a first rail 82 and a second rail 84 as shown in FIGS. 5 and 6. The first rail 82 and the second rail 84 are included in the backrest and extend along a height thereof. Each rail 82, 84 is formed to include a plurality of apertures 85 configured to engage selectively with a portion of the headrest 80 to block movement of the headrest 80 along the rails 82, 84. The access panel 64 is located laterally between the first rail 82 and the second rail 84.

The first and second rails 82, 84 are included in a main structural frame of the child restraint 10. The frame further includes one or more belt-path supports 86 coupled the rails 82, 84 and extending around the first belt path 34 at a rear end of the juvenile seat 30 as shown in FIG. 7. Forces acting on the child restraint 10 by the vehicle seat belt in the first belt path 34 during a front impact, for example, are transferred into the belt-path supports 86 so that the frame secures the child restraint 10.

The seat base 20 further includes a recline foot 90 as shown in FIG. 3. The recline foot 90 is configured to adjust a tilted orientation of the child restraint 10 relative to the vehicle seat. The recline foot 90 pivots relative to the rest of the seat base 20 to extend and retract from a cavity formed in the seat base 20. Placing the recline foot 90 in the seat base 20 frees space in the juvenile seat 30 for the belt paths 34, 36, 38, but also takes up space in the seat base 20. The size of the seat base 20 is kept small by omitting belt paths in the seat base 20 for the vehicle seat belt.

A child restraint 10 in accordance with the present disclosure is shown in FIG. 1 and includes a seat base 20 and juvenile seat 30 coupled to the seat base 20. The seat base 20 is adapted to rest on an underlying vehicle seat. The seat base 20 is shaped to form a recessed area 22 to receive the juvenile seat 30. The recessed area 22 is shaped to allow the juvenile seat 30 to rotate relative to the seat base 20 between different orientations to provide multiple modes of the child restraint 10.

The juvenile seat 30 is coupled to the seat base 20 for rotation about a vertical axis 32 between a forward-facing orientation, as shown in FIGS. 1-6, and a rearward-facing orientation, as shown in FIG. 7. The juvenile seat 30 is shaped to provide means for securing the juvenile seat 30 to the vehicle seat: (i) in the forward-facing orientation by routing an attachment belt along a first belt path 34 formed in the juvenile seat 30 to establish a forward-facing seating mode, (ii) in the forward-facing orientation by routing the attachment belt along a second belt path 36 formed in the juvenile seat 30 to establish a forward-facing booster mode, and (iii) in the rearward-facing orientation by routing the attachment belt along a third belt path 38 formed in the juvenile seat 30 to establish a rearward-facing seating mode without securing the seat base 20 to the vehicle seat so that the juvenile seat 30 remains attached to the seat base 20 during installation of the child restraint 10 on the vehicle seat the seat base 20 and does not include a belt path to minimize a size of the seat base 20.

The juvenile seat 30 includes a seat bottom 40, a backrest 42 coupled to and extending upwards from the seat bottom 40, a pair of upper side panels 44 disposed on either side of the backrest 42, and a pair of lower side panels 46 disposed on either side of the bottom 40. The bottom 40 forms a bottom seating surface of the juvenile seat 30, extending between a rear and a front of the juvenile seat 30. The backrest 42 forms a back seating surface of the juvenile seat 30. The backrest 42 extends generally upwards from a rear portion of the bottom 40 at an angle relative to the bottom 40. The bottom 40 and the backrest 42 cooperate to form a seating area 50 for a child to sit and/or be placed in when sitting in the child restraint 10. The bottom 40 and the backrest 42 are rotated relative to the seat base 20 between the forward-facing orientation, as shown in FIGS. 1-6, and the rearward-facing orientation, as shown in FIG. 7. In the forward-facing orientation, the bottom 40 is disposed closer to a front 12 of the child restraint 10 than the backrest 42, as shown in FIGS. 3-4. In the rearward-facing orientation, as shown in FIG. 6, the backrest 42 is disposed closer to the front 12 of the child restraint 10 than the bottom 42.

Each of the lower side panels 46 is coupled to an opposite side of the bottom 40. The lower side panels 46 extend away from the bottom 40 towards the backrest 42 of the juvenile seat 30. The lower side panels 46 extend upwards at an angle relative to the bottom 40 to define a lower portion 52 of the seating area 50 with the bottom 40. Each of the upper side panels 44 is coupled to an opposite side of the backrest 42. The upper side panels 44 extend away from the backrest 42, towards the bottom 40 of the juvenile seat 30. The upper side panels 44 extend at an angle relative to the backrest 42 to define an upper portion 54 of the seating area 50 with the backrest 42.

The backrest 42, bottom 40, and the side panels 44, 46 are shaped to form apertures 41, 43, and slots 45 that define the first belt path 34, second belt path 36, and third belt path 38, respectively. The belt paths 34, 36, and 38 are used to secure the seat base 20 to the underlying vehicle seat to cause the juvenile seat 30 to remain attached to the seat base 20. The belt paths 34, 36, and 38 allows for a size of the seat base 20 to be minimized or simplified as the seat base 20 does not include a belt path for securing the child restraint to the vehicle seat. The juvenile seat 30 and built-in belt paths 34, 26, 38 also provide a means for determining the mode or configuration of the child restraint 10 by rotating relative to the seat base 20 between the forward-facing and rearward-facing orientations such that the seat is in a forward-facing seating mode, the forward-facing booster mode, or the rearward-facing seating mode, and the attachment belt is routed through the juvenile seat 30, along the belt path that corresponds to the mode of the child restraint.

The backrest 42 is shaped to form two upper apertures 41 at the back of the juvenile seat 30, through which the attachment belt can extend from an outer surface of the juvenile seat to an inner surface of the juvenile seat 30 facing the seating area 50. The upper apertures 41 define the first belt path 34 that is used when the child restraint 10 is in forward-facing seating mode, as shown in FIG. 2. The lower side panels 46 are shaped to each form a lower aperture 43 on either side of the bottom 40 of the juvenile seat 30, through which the attachment belt can extend from an outer surface of the juvenile seat to an inner surface of the juvenile seat 30 facing the seating area 50. The lower apertures 43 define the third belt path 38 that is used when the child restraint 10 is in the rearward-facing seating mode, as shown in FIG. 2.

The upper side panels 44 and the lower side panels 46 cooperate to define a slot 45 between the upper 44 and lower side panel 46 on either side of the juvenile seat 30. The attachment belt can extend through the slot 45 from an outer surface of the juvenile seat to an inner surface of the juvenile seat 30 facing the seating area 50. The slots 45 define the second belt path 36 that is used when the child restraint 10 is in forward-facing booster mode, as shown in FIG. 2.

The child restraint 10 includes a belt lock-off 60 coupled to the backrest 42 and located in a cavity 62 formed in the backrest 42 behind the back seating surface of the juvenile seat 30, as shown in FIG. 4. The belt lock-off 60 lies along the first belt path 34 to receive and clamp down on the attachment belt in the forward-facing seating mode. An access panel 64 is included in the backrest 42 and is movable relative to the rest of the juvenile seat 30 to open and close the cavity 62 and provide access to the belt lock-off 60, as shown in FIG. 6. The access panel provides at least a portion of the back seating surface of the juvenile seat 30.

1. A child restraint comprising
a seat base adapted to rest on an underlying vehicle seat and
a juvenile seat coupled to the seat base and configured to rotate relative to the seat base about a vertical pivot axis between a forward-facing orientation and a rearward-facing orientation, the juvenile seat including a seat bottom coupled to the seat base and a backrest coupled to the seat bottom and arranged to extend in an upward direction away from the seat bottom,
wherein the juvenile seat is formed to include: (i) a first belt path formed in the backrest and configured to receive a vehicle seat belt when the juvenile seat is in the forward-facing orientation to establish a forward-facing seating mode, (ii) a second belt path formed in the seat bottom and located forward of the first belt path relative to the vertical pivot axis and a front end of the juvenile seat and configured to receive the vehicle seat belt when the juvenile seat is in the forward-facing orientation to establish a forward-facing booster mode, and (iii) a third belt path formed in the seat bottom and located forward of the second belt path relative to the vertical pivot axis and the front end of the juvenile seat and configured to receive the vehicle seat belt when the juvenile seat is in the rearward-facing orientation to establish a rearward-facing seating mode.

2. The child restraint of claim 1, wherein the seat base is formed without any belt paths for attaching the child restraint to the vehicle seat using the vehicle seat belt.

3. The child restraint of claim 1, wherein the seat base has a first height from a lower end of the seat base engaged with the vehicle seat to an uppermost end of the seat base spaced apart from the vehicle seat, and the backrest of the juvenile seat has a second height from the uppermost end of the seat base to an uppermost end of the backrest, the second height being greater than the first height.

4. The child restraint of claim 3, wherein the first belt path is located above the uppermost end of the seat base when the juvenile seat is in the forward-facing orientation.

5. The child restraint of claim 3, wherein the third belt path is located at least partially above the upper most end of the seat base when the juvenile seat is in the rearward-facing orientation.

6. The child restraint of claim 1, wherein the first belt path, the second belt path and the third belt path are each located above a plane extending from an uppermost end of the seat base to a point along the vertical pivot axis and perpendicular to the vertical pivot axis.

7. The child restraint of claim 1, wherein the backrest includes a seating surface configured to support a portion of a child seated on the juvenile seat and a rear surface facing away from the seating surface and spaced apart from the seating surface to provide a cavity between the seating surface and the rear surface, and wherein the first belt path extends through the cavity.

8. The child restraint of claim 7, wherein the juvenile seat further includes a belt lock-off located in the cavity to retain the vehicle seat belt in the forward-facing seating mode.

9. The child restraint of claim 8, wherein the backrest includes a backrest panel and an access panel coupled to the backrest panel for pivotable movement relative to the backrest panel between a closed position at least partially providing the seating surface and an opened position exposing the cavity from a front end of the juvenile seat to access the belt lock-off and for routing the vehicle seat belt through the first belt path.

10. A child restraint comprising
a seat base adapted to rest on an underlying vehicle seat,
a juvenile seat coupled to the seat base and including a seat bottom coupled to the seat base and a backrest coupled to the seat bottom and arranged to extend in an upward direction away from the seat bottom, wherein the juvenile seat is formed to include: (i) a first belt path formed in the backrest and configured to receive a vehicle seat belt when the juvenile seat is in a forward-facing orientation to establish a forward-facing seating mode, (ii) a second belt path formed in the seat bottom and located forward of the first belt path relative to a front end of the juvenile seat and configured to receive the vehicle seat belt when the juvenile seat is in the forward-facing orientation to establish a forward-facing booster mode, and (iii) a third belt path formed in the seat bottom and located forward of the second belt path relative to the front end of the juvenile seat and configured to receive the vehicle seat belt when the juvenile seat is in the rearward-facing orientation to establish a rearward-facing seating mode, and
a belt lock-off coupled to the backrest and located in the first belt path to retain the vehicle seat belt when the juvenile seat is in the forward-facing seating mode,
wherein the backrest includes a seating surface configured to support a portion of a child seated on the juvenile seat and a rear surface facing away from the seating surface and spaced apart from the seating surface to provide a cavity between the seating surface and the rear surface, and wherein the first belt path extends through the cavity and the belt lock-off is located in the cavity between the seating surface and the rear surface.

11. The child restraint of claim 10, wherein the backrest includes a backrest panel and an access panel coupled to the backrest panel for pivotable movement relative to the backrest panel between a closed position at least partially providing the seating surface and an opened position exposing the cavity from a front end of the juvenile seat to access the belt lock-off and for routing the vehicle seat belt through the first belt path.

12. The child restraint of claim 10, wherein the seat base is formed without any belt paths for attaching the child restraint to the vehicle seat using the vehicle seat belt.

13. The child restraint of claim 10, wherein the seat base has a first height from a lower end of the seat base engaged with the vehicle seat to an uppermost end of the seat base spaced apart from the vehicle seat, and the backrest of the juvenile seat has a second height from the uppermost end of the seat base to an uppermost end of the backrest, the second height being greater than the first height.

14. The child restraint of claim 13, wherein the first belt path is located above the uppermost end of the seat base when the juvenile seat is in the forward-facing orientation.

15. The child restraint of claim 13, wherein the third belt path is located at least partially above the upper most end of the seat base when the juvenile seat is in the rearward-facing orientation.

16. The child restraint of claim 10, wherein the first belt path, the second belt path and the third belt path are each located above a plane extending from an uppermost end of the seat base to a point along the vertical pivot axis and perpendicular to the vertical pivot axis.

17. A juvenile seat comprising
a seat bottom,
a backrest coupled to the seat bottom and arranged to extend in an upward direction away from the seat bottom, the backrest being formed to include a belt path, and
a belt lock-off coupled to the backrest and located in the belt path to retain an attachment belt configured to secure the juvenile seat to a vehicle seat,
wherein the backrest includes a seating surface configured to support a portion of a child seated on the juvenile seat and a rear surface facing away from the seating surface and spaced apart from the seating surface to provide a cavity between the seating surface and the rear surface, and wherein the first belt path extends through the cavity and the belt lock-off is located in the cavity.

18. The juvenile seat of claim 17, wherein the backrest includes a backrest panel and an access panel coupled to the backrest panel for pivotable movement relative to the backrest panel between a closed position at least partially providing the seating surface and an opened position exposing the cavity from a front end of the juvenile seat to access the belt lock-off and for routing the vehicle seat belt through the belt path.

19. The juvenile seat of claim 17, wherein the seat base is formed without any belt paths for attaching the child restraint to the vehicle seat using the vehicle seat belt.

20. The juvenile seat of claim 17, wherein the belt path is located above the uppermost end of the seat base when the juvenile seat is in the forward-facing orientation.
